(19) United States
(12) Patent Application Publication
(10) Pub. No.: US 2003/0070142 A1
(43) Pub. Date: Apr. 10, 2003

(54) Self-contained validation of data model object content

(75) Inventors: Daniel R. Drake, Apex, NC (US); James E. Fox, Apex, NC (US); Robert C. Leah, Cary, NC (US); Erich S. Magee, Morrisville, NC (US); Robert C. Sizemore, Fuquay-Varina, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 09/974,688

(22) Filed: Oct. 10, 2001

(51) Int. Cl. G06F 17/30

(52) U.S. Cl. 715/513

(57) ABSTRACT

Methods, systems, and computer program products for improving validation of data. Validation is coupled with, or encapsulated with, the data values to which the data validation pertains, thereby becoming a part of the data model itself. This approach enables real-time data validation, as a user interacts with a data model through an executing application or GUI window interface. In some embodiments, the data model (and the encapsulated validation) is expressed using markup language notation.

### BACKGROUND OF THE INVENTION

1. Field of the Invention

The present invention relates to computer programming, and deals more particularly with improved techniques for validating data.

2. Description of the Related Art

Use of computers in today's society has become pervasive. Many software applications accept input data and perform some type of validation on that data. When the input data is to be received from a human user, a graphical user interface (“GUI”) is often used for soliciting that data from the user. Typically, the data is validated after entry by the user, and if the validation detects some type of error condition, an error message can be presented to the user. The data can be re-solicited until an acceptable value is obtained (or, in some cases, the data entry process is terminated without obtaining an acceptable value, such as when the user fails to provide a valid password after several attempts).

Practitioners of the software programming art have long been familiar with the means by which validation is logically linked to a data entry facility or widget. As one example of this linking, a software program might contain hard-coded logic for displaying a data entry field and then validating input received from that field, such as determining whether the received input has an appropriate length and uses acceptable characters. In the case of a social security number, for example, the validation may comprise ensuring that exactly 9 digits have been provided. In object-oriented programming, the logical linking may comprise associating a property with an entry field GUI widget, where the property describes rules such as the data length and character set.

While prior art data validation approaches may be functionally sufficient, there is room for improvement.

### SUMMARY OF THE INVENTION

An object of the present invention is to provide improved data validation techniques.

It is another object of the present invention to provide improved data validation by coupling validation of data to the data model (or data structure) itself.

Another object of the present invention is to provide this coupling for data and data models which are expressed in structured markup language notation.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for improving data validation. In one aspect, this technique comprises defining one or more validation criteria and encapsulating the defined validation criteria with a data model to which they apply. The technique may also comprise using the defined validation criteria to validate a data value for the data model. The data model and/or the validation criteria may be expressed in a markup language notation, such as the XML (“Extensible Markup Language) notation.

The present invention will now be described with reference to the following drawings, in which like reference numbers denote the same element throughout.

### BRIEF DESCRIPTION OF THE DRAWINGS

FIG. 1 illustrates a data model which encapsulates data validation as well as data, according to the present invention;

FIG. 2 illustrates how the data model of FIG. 1 allows data and its validation to be easily and efficiently shared among multiple presentations;

FIG. 3 shows a sample data model validation object created according to an embodiment of the present invention;

FIG. 4 provides a flowchart depicting logic underlying an implementation of the present invention; and

FIGS. 5A and 5B show sample code which may be used to perform validation of data, according to preferred embodiments of the present invention.

### DESCRIPTION OF PREFERRED EMBODIMENTS

The present invention defines novel techniques for performing data validation. Validation is coupled with, or encapsulated with, the data values to which the data validation pertains, thereby becoming a part of the data model itself. This approach enables real-time data validation, as a user interacts with a data model through an executing application or GUI window interface.

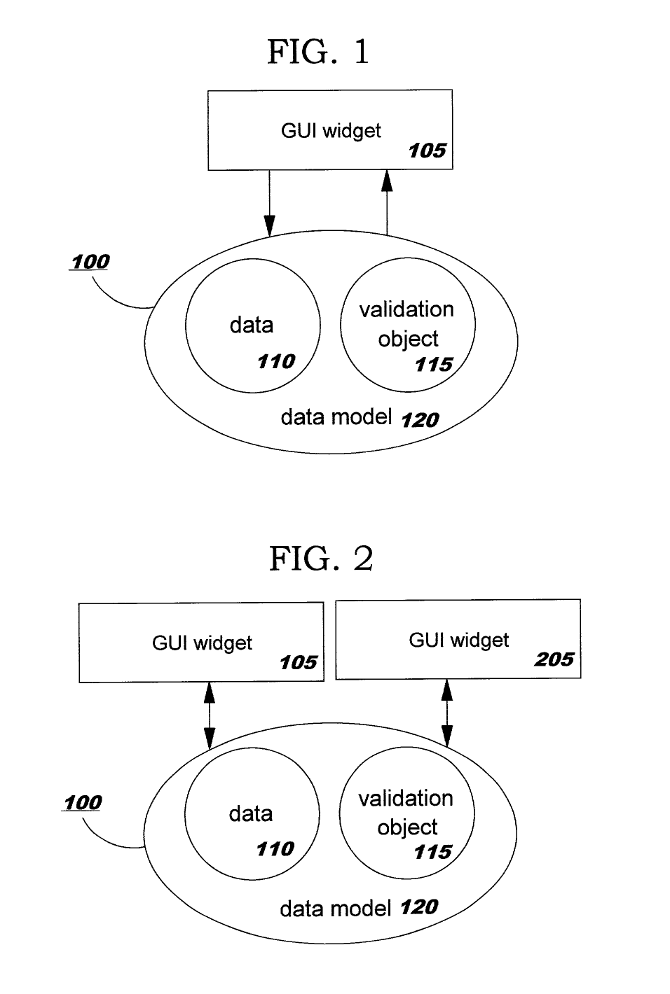

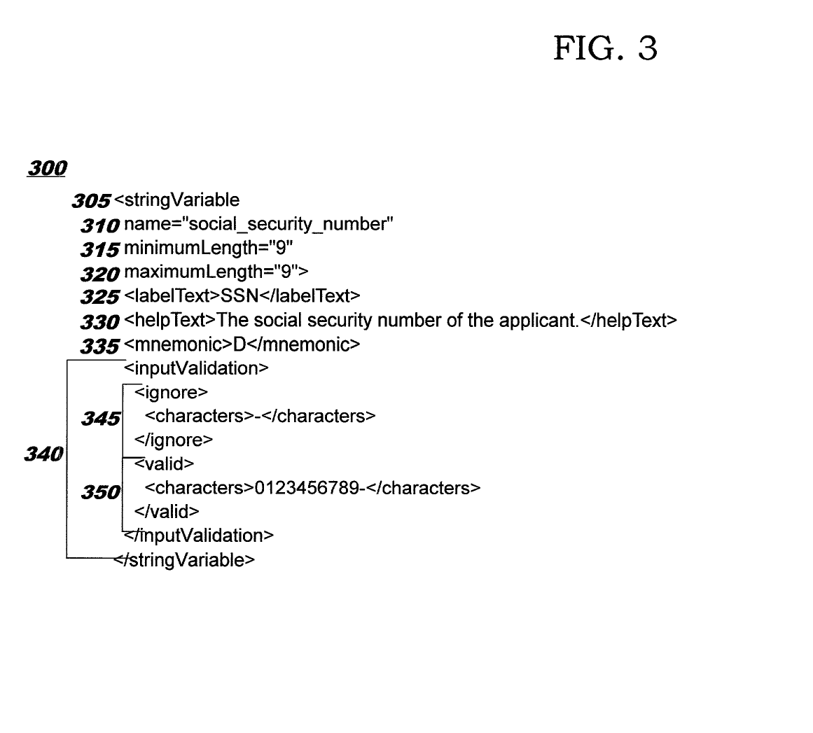

This data model is illustrated in FIG. 1. See generally element 100, in which data model 120 encapsulates data 110 and also a set of validation criteria 115. This data model 100 may interact with a GUI widget 105 which stores data in the model and/or retrieves stored data, typically when interacting with an end user. (Interaction is discussed further below with reference to FIG. 2 as well.) In object oriented programming terms, the coupling of the validation and the data forms a complex object.

The approach of the present invention offers a number of advantages over prior art validation techniques. As one advantage, because validation criteria (such as rules which describe acceptable data values and formats) can now float with the data model, and therefore with the data values. That is, the validation can travel with the data values, from one implementation to another, as if the validation was simple data. The object containing the data and its validation can be passed between applications, stored, and so forth, and the receiving application need not be aware that validation is contained within the object it is operating upon.

Another advantage of the present invention is that the validation process is handled at an early point, that is, when the data model is being populated. This is especially beneficial if the data model is being pre-loaded with data values, for example before presenting a GUI display of default values to a user. Validation may also be performed as an application mutates data values. In prior art approaches, validation typically does not occur until run-time.

A further advantage of the present invention is that separating the data validation from the GUI allows for easily and efficiently sharing the data and data validation among multiple presentations. This is illustrated by FIG. 2. For a particular data model 100, either GUI widget 105 or GUI widget 205 might be used to display the contained data 110 to a user, and to validate any revised data values the user provides, according to the single shared validation object 115. For example, suppose data 110 contains a user's home phone number. GUI widget 105 might display this data value using a text field widget that allows modifying the existing phone number. GUI widget 205, on the other hand, might display this data value as a label in a radio button list, along with the user's work phone number as the label of another radio button. Rather than including validation rules regarding proper values for phone numbers, and proper formatting of phone numbers, in each widget as is typically done in prior art approaches, the widgets 105 and 205 rely on the data model 100 to handle these details. Similarly, if a given GUI window includes many different types of data, the window and its widgets can delegate responsibility for validating these various types of data to the data models. Because the data models are already designed to store a particular type of data, very little additional effort should be required for a designer to incorporate the validation directly into the data model once the teachings of the present invention are known. This approach also reduces the amount of code required for the GUI widgets, lowers their complexity, and increases their reusability.

Prior art approaches to validation typically tie the validation to a GUI. Separating validation from the GUI itself, according to the present invention, allows changes to a GUI to be implemented more easily and more quickly. The GUI developer can focus on the GUI layout and GUI widgets, and need not be concerned with the validation rules for the data and the effect of those rules on the data.

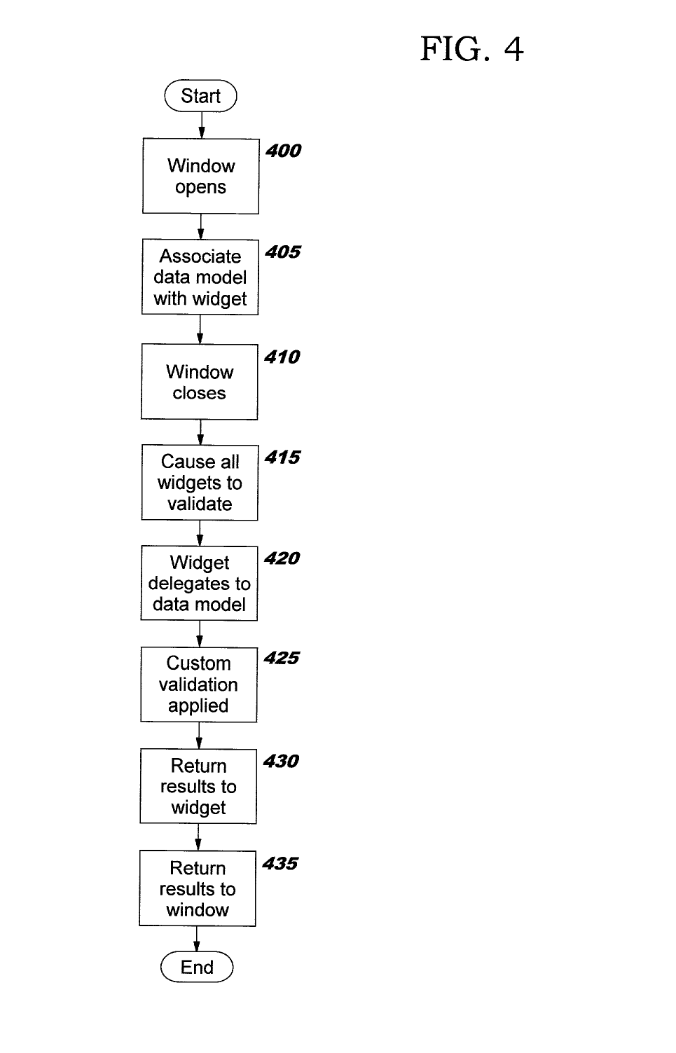

In one embodiment of the present invention, data models are expressed using structured markup language notation. As one example, XML may be used to encode data model objects which include data values as well as data validation. (It should be noted that references herein to XML are for purposes of illustration and not of limitation.) FIG. 3 illustrates a sample validation object 300 for use when storing a social security number, and the rules contained therein are designed specifically for social security numbers. In particular, the rules reflect that such numbers contain exactly nine digits, and may optionally contain dashes, but are not allowed to contain any other types of special characters or letters. Validation object 300 will now be described in more detail, as an example of the general principles of the present invention.

According to preferred embodiments of the present invention, validation rules for string data specify a minimum length and a maximum length as attributes; in the example of FIG. 3, the length restriction is specified using the value of “9” for both the minimum and maximum (see elements 315 and 320). The tag “stringVariable” indicates that the rules 305 pertain to a string data type. In addition to minimum and maximum length attributes, each string tag includes a name attribute 310. Optionally, string tags may also include attributes specifying string-related information such as whether data values are to be enforced as all upper case or all lower case; by default, mixed case is preferably allowed.

Optionally, the string tag may include a label child tag 325 which specifies how the associated data should be described on a widget (such as a button or entry field) that may be generated on a GUI. In the example, a label value “SSN” has been provided. Additional optional child tags are a help text tag 330, which provides help text (or a reference to stored help text, using for example a Uniform Resource Locator or other file identifier) pertaining to the associated data, and a mnemonic tag 335, which defines a hot key value to be used for this widget on the GUI.

The input validation rules for the social security number example specified in the “inputValidation” tag 340 include ignoring the dash characters (see 345) and allowing as valid characters only entry of digits and dashes (see 350).

The validation object 300 may be associated with any variable in which a social security number is to be stored. It will be obvious how this approach may be used to specify validation rules for other types of string variables as well as for other data types. Preferably, other data types use attributes and child tags which are adapted to those data types. Additional or different data types may be supported without deviating from the inventive concepts disclosed herein.

According to preferred embodiments of the present invention, the validation object for each data type includes a name attribute which names the variable to which this validation object applies, and the label text, help text, mnemonic, and inputValidation child tags preferably apply to each data type as described with reference to FIG. 3.

The validation may be activated by various events, as reflected by an application developer. For example, validation may be invoked when a user clicks on a button, or when a window or widget loses focus (indicating that the user has moved on to another window or widget), and so forth.

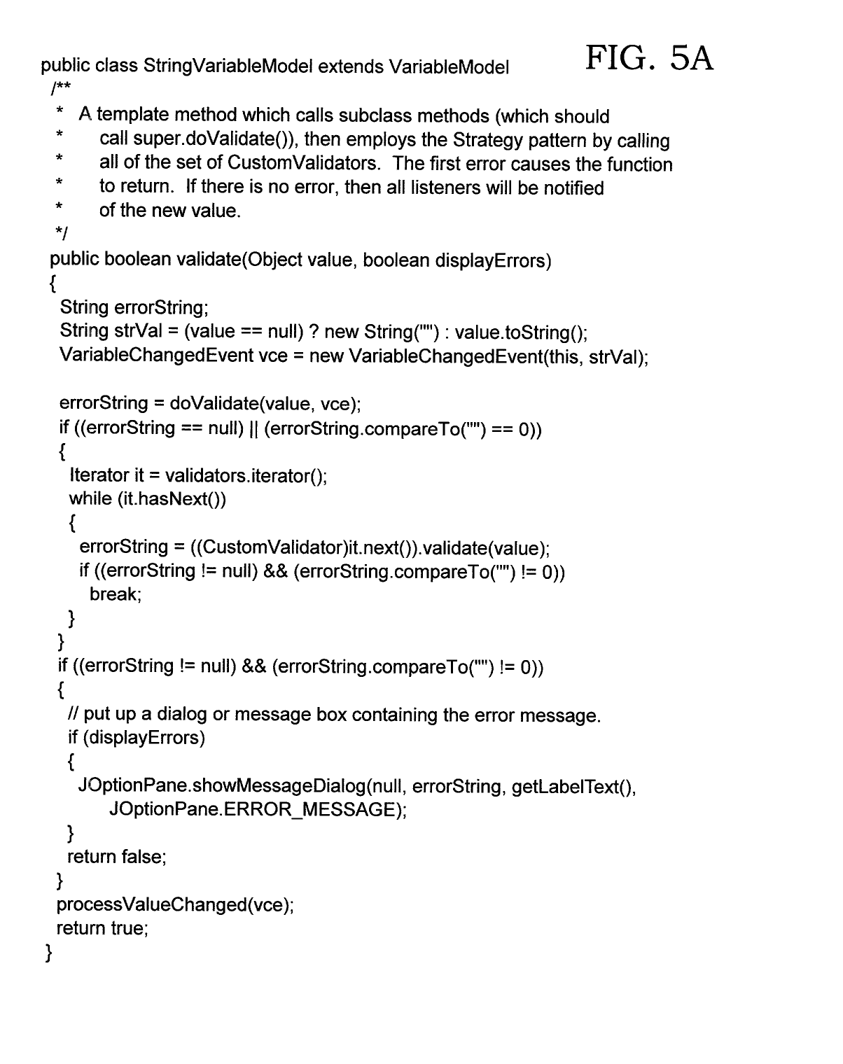

Turning now to FIG. 4, logic underlying an implementation of the present invention is provided. As shown in Block 400, a GUI window is opened for user interaction. A data model is associated with a widget from this GUI (Block 405), and the user then interacts with that data model through the GUI widget. When the window closes (Block 410), all the window's widgets preferably invoke their validation methods (Block 415). (As discussed earlier, validation may alternatively be triggered at other times or in response to other events.) In Block 420, the widget then delegates the validation to the data model, according to the present invention. The custom validation defined in the data model is applied (Block 425), and the results are returned to the widget (Block 430). The widget then preferably returns these results to the window (Block 435). The processing of the current invocation of FIG. 4 then ends.

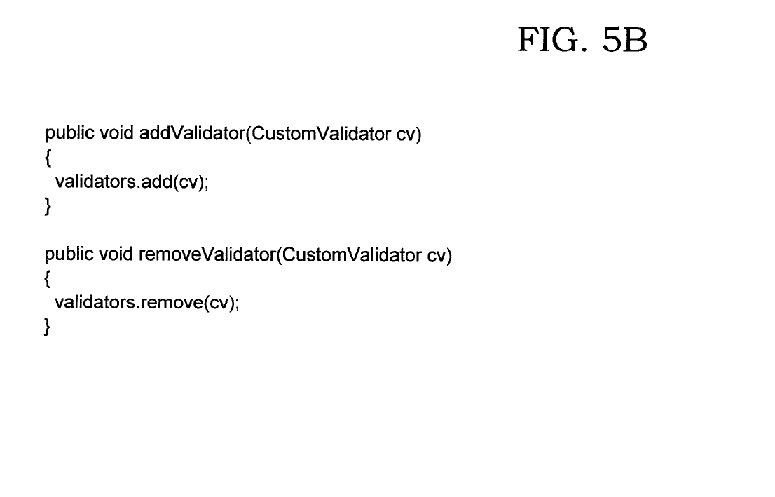

Sample code which may be used to perform validation of data according to preferred embodiments of the present invention is shown in FIGS. 5A and 5B. As can be seen from inspection of this code, the data model recognizes that data has been changed (for example, when a user provides a revised data value) through a variable changed event. When this event is triggered, it launches the validation process. The data model has standard local validation in a “doValidate” method. It then looks for installed instances of a custom validator, such as those described using XML notation in FIG. 3. For any custom validators that are found, the custom validation is executed. This effectively allows plugging and unplugging of validation code. Validators can be added or removed using the addValidator or removeValidator methods. The “validate” method serves as an entry point to this code, and is invoked according to the developer's code hooks, as discussed earlier.

In prior art approaches, developers typically rely on the native capabilities of each widget. For example, when using an interactive development environment such as VisualAge® from IBM, a panel designer creates a panel layout and specifies error checking on the widget itself. (“VisualAge” is a registered trademark of IBM.) An alternative prior art approach is to hardcode the error checking in-line into an application, as discussed earlier. This error-checking code becomes a fixed, static part of the application, and any changes to the data validation require changing the application itself. As is known in the art, changes of this type may become quite complex and may be quite time-consuming, tedious, and error-prone for large applications. Using the techniques of the present invention, on the other hand, the validation is isolated with the data model, and changes thereto may be made more easily and quickly and do not require changing the application itself.

The disclosed techniques enable a consumer of information to fire a validation without concern over what that validation does. That is, the consumer does not need to contain data-dependent validation for data that it may receive from another source. Instead, the data includes its own validation, because the data and validation are packaged together. Furthermore, the consumer can mutate the data, and the self-contained validation will ensure that the result remains valid (or that the mutation is prevented).

The techniques of the present invention may be used to provide support for “VariableModel” class which was described in commonly-assigned U.S. Pat. No. ______ (Ser. No. 09/669,227, filed Sep. 25, 2000), titled “Object Model and Framework for Installation of Software Packages Using JavaBeans™”. This patent is hereby incorporated herein by reference as if set forth fully.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flow diagrams and/or block diagrams of methods, apparatus (systems) and computer program products according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include the preferred embodiments and all such variations and modifications as fall within the spirit and scope of the invention.

What is claimed is:

1. A method of improving data validation, comprising steps of:
defining one or more validation criteria; and
encapsulating the defined validation criteria with a data model to which they apply.

2. The method according to claim 1, further comprising the step of using the defined validation criteria to validate a data value for the data model.

3. The method according to claim 1, wherein the validation criteria are expressed in a markup language notation.

4. The method according to claim 3, wherein the markup language notation is XML (“Extensible Markup Language) notation.

5. The method according to claim 1, wherein the data model and the validation criteria are expressed in a markup language notation.

6. A system for improving data validation, comprising:
means for defining one or more validation criteria;
means for encapsulating the defined validation criteria with a data model to which they apply; and
means for using the defined validation criteria to validate a data value for the data model.

7. The system according to claim 6, wherein the data model and the validation criteria are expressed in a markup language notation.

8. The system according to claim 7, wherein the markup language notation is XML (“Extensible Markup Language) notation.

9. A computer program product for improving data validation, the computer program product embodied on one or more computer-readable media and comprising:
computer-readable program code means for defining one or more validation criteria;
computer-readable program code means for encapsulating the defined validation criteria with a data model to which they apply; and
computer-readable program code means for using the defined validation criteria to validate a data value for the data model.

10. The computer program product according to claim 9, wherein the data model and the validation criteria are expressed in a markup language notation.

11. The computer program product according to claim 10, wherein the markup language notation is XML (“Extensible Markup Language) notation.
